(19) United States
(12) Patent Application Publication
(10) Pub. No.: US 2004/0119604 A1
(43) Pub. Date: Jun. 24, 2004

(54) Luminescent device for equipping with electronic product for luminescent and decorative purposes

(76) Inventor: Gui You Yu, Shenzhen (CN)

Correspondence Address: Raymond Y. Chan, 108 N. Ynez Avenue, Suite 128, Monterey Park, CA, 91754, US

(21) Appl. No.: 10/329,159

(22) Filed: Dec. 24, 2002

(51) Int. Cl. G08B 5/22

(52) U.S. Cl. 340/815.45

(57) ABSTRACT

A luminescent device is provided to be mounted on a surface of a shell of an electronic product or mounted in an electronic product for luminescent and decorative purposes thereof. The luminescent device includes a circuit board connected to the electronic product, a luminescent unit mounted on the circuit board, an integrated module that controls the luminescent unit and a trigger that receives trigger signal and sends control signal to said integrated module. The luminescent device can make different luminescent effects, so as to enhance the display function and decorative effect of a mobile phone or other electronic products.

### BACKGROUND OF THE PRESENT INVENTION

1. Field of Invention

This invention relates to a luminescent device, which can be attached on the surface of an electronic product or be mounted in an electronic product, and by which the trigger signal detects control signal and triggers the luminescence of electronic product.

2. Description of Related Arts

Among existing telecom products or other electronic products, such as telephone and mobile phone, their initial information of an incoming call is usually realized by self-set ringing. When a mobile phone rings for an incoming call, its screen can g ive our light and display the incoming c all, enabling the consumer to get further related information via the screen. However, this screen luminescence is not decorative, and thus is less attractive to consumers.

Such decorative articles matching telecom products or other electronic products as tiny floss doll, beautiful hanger and appealing PVC paster, are available in current market. Although they play as decorations of electronic products and meanwhile, they are favored by some consumers (especially ladies), the decorations are of low technological content, single function, and thus fail to satisfy the high-taste demand of the vast majority of consumers at present.

As for existing electronic billboard, it is very decorative and eye-catching when giving out light at night, but it's usually operated manually, which is insufficient in automation, and it's usually powered by municipal power supply, which is restricted by its location. Thus it's also inconvenient of installation and operation, and of low applicability.

With the continuous progress of technology and upgrade of products, an electroluminescent (EL) light mobile phone technology has come forth. That is, when the mobile phone receives an incoming call, not only its screen will give out light and display the incoming call, but also its cover will give out lights of various shapes. This EL light mobile phone does not need external power supply. It takes mobile phone battery as its power supply for EL light and EL, as the conductor, is pasted on the surface of the back cover to make EL light effect for the mobile phone cover. Although these electronic products are of high technological content with decorative function, they consume considerable electricity when working, leading to frequent charging and causing great inconveniences to consumers. Moreover, these products are of high production cost and complex technology, resulting in a relative high price and low reliability. So its market prospect is not bright.

### SUMMARY OF THE PRESENT INVENTION

The object of the invention is to provide a luminescent device, which can be attached on the surface of the shell of an electronic product or be mounted in an electronic product for luminescent and decorative purposes of the electronic product.

Another object of the invention is to provide a luminescent device, which is of high technical content, good reliability, simple and flexible structure.

To such end, a luminescent device is thus created to be mounted on the surface of the shell of an electronic product or mounted in an electronic product. The device consists of a circuit board connected to the mentioned electronic product, a luminescent unit mounted on the mentioned circuit board, an integrated module that controls the mentioned Luminescent unit and a trigger that receives trigger signal and sends control signal to the mentioned integrated module.

In the above device, the trigger mounted on the mentioned circuit board is an electric signal trigger.

In the above device, the mentioned circuit board is mounted between the front cover of the battery plate and the battery cell of a mobile phone. The mentioned luminescent unit is several light-emitting diodes regularly distributed on the mentioned circuit board. The mentioned several light-emitting diodes are diodes of a same color or those of different colors. The mentioned luminescent unit consists of several luminescent components that are set up on the mentioned circuit board in a way that forms a pattern. Each of the luminescent components includes a small circuit board, several light-emitting diodes on the mentioned small circuit board in parallel connection or in series and a luminescent element between two adjacent luminescent components as well as luminescent elements around the mentioned small circuit board. The mentioned luminescent unit consists of several luminescent components installed on the mentioned circuit board in away of character combination. Each of the luminescent components includes a small circuit board, several light-emitting diodes on the mentioned small circuit board in parallel connection or in series and luminescent elements installed around the mentioned several luminescent components.

In the above luminescent device, the mentioned circuit board is mounted on the shell of a mobile phone. The mentioned luminescent unit is several light-emitting diodes regularly distributed on the circuit board. The said several light-emitting diodes are diodes of a same color or those of different colors. The luminescent unit consists of several luminescent components that are set up on the circuit board in a way that forms a pattern. Each of the luminescent components includes a small circuit board, several light-emitting diodes on the mentioned small circuit board in parallel connection or in series and a luminescent element between two adjacent Luminescent components as well as luminescent elements around the mentioned small circuit board. The mentioned luminescent unit consists of several luminescent components installed on the mentioned circuit board in away of character combination. Each of the luminescent components includes a small circuit board, several light-emitting diodes on the mentioned small circuit board in parallel connection or in series and Luminescent elements installed around the mentioned several luminescent components.

In the above luminescent device, the mentioned circuit board is mounted on the shell of a carphone charger. The mentioned luminescent unit is several light-emitting diodes regularly distributed on the mentioned circuit board. The mentioned several light-emitting diodes are diodes of a same color or those of different colors. The luminescent unit consists of several luminescent components that are set up on the mentioned circuit board in a way that forms a pattern. Each of the luminescent components includes a small circuit board and several light-emitting diodes on the mentioned small circuit board in parallel connection or in series.

In the above luminescent device, the mentioned exposed surfaces of the mentioned light-emitting diodes are covered with crystal mixed glue or light guide crystal mixed glue.

In the luminescent device, the trigger mounted between the mentioned circuit board is a sensor. The mentioned sensor is an option of an optical control sensor, an acoustic control sensor or an infrared sensor.

In the luminescent device, the said circuit board is mounted between the front cover and back cover of an electronic billboard. The luminescent unit is several light-emitting diodes regularly distributed on the mentioned circuit board. The several light-emitting diodes are diodes of a same color or those of different colors. The mentioned luminescent unit consists of several luminescent components installed on the mentioned circuit board in away of character combination. Each of the luminescent components includes a small circuit board, several light-emitting diodes on the mentioned small circuit board in parallel connection or in series and luminescent elements installed around the mentioned several luminescent components.

In the luminescent device, the mentioned circuit board is mounted on the shell of an electronic billboard. The luminescent unit is several light-emitting diodes regularly distributed on the mentioned circuit board. The mentioned several light-emitting diodes are diodes of a same color or those of different colors. The luminescent unit consists of several Luminescent components installed on the mentioned circuit board in away of character combination. Each of the luminescent components includes a small circuit board, several light-emitting diodes on the mentioned small circuit board in parallel connection or in series and luminescent elements installed around the mentioned several Luminescent components.

### BRIEF DESCRIPTION OF THE DRAWINGS

FIG. 1 is a structural representation of Example 1 of embodiment of the invention as a luminescent device.

FIG. 2 is a structural representation of a structural representation of the circuit board of the luminescent device shown in FIG. 1.

FIG. 3 is a perspective structural representation of the luminescent device mounted in a mobile phone.

FIG. 4 is a schematic circuit diagram of the luminescent device shown in FIG. 1.

FIG. 5 is a structural representation of Example 2 of embodiment of the invention as a luminescent device.

FIG. 6 is a perspective structural representation of the luminescent device mounted in an electronic billboard shown in FIG. 5.

FIG. 7 is a structural representation of Example 3 of embodiment of the invention as a luminescent device.

FIG. 8 is a structural representation of the light-emitting diodes in parallel connection in the luminescent unit shown in FIG. 7.

FIG. 9 is a structural representation of the light-emitting diodes in series in the luminescent unit shown in FIG. 7.

FIG. 10 is a structural representation of Example 4 of embodiment of the invention as a luminescent device.

FIG. 11 is a structural representation of the light-emitting diodes in series in the luminescent unit shown in FIG. 10.

### DETAILED DESCRIPTION OF THE PREFERRED EMBODIMENT

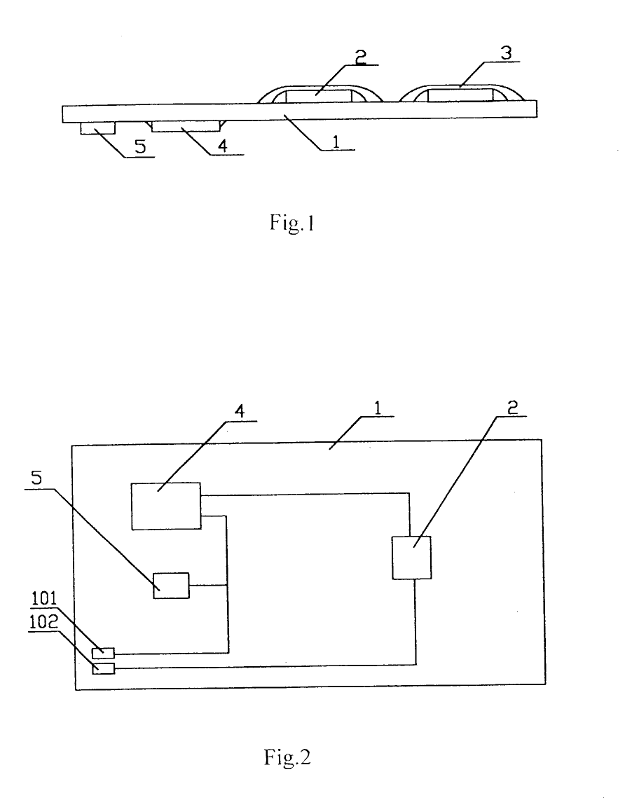

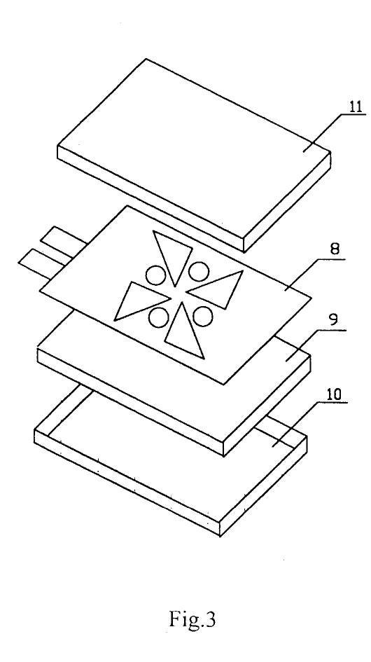

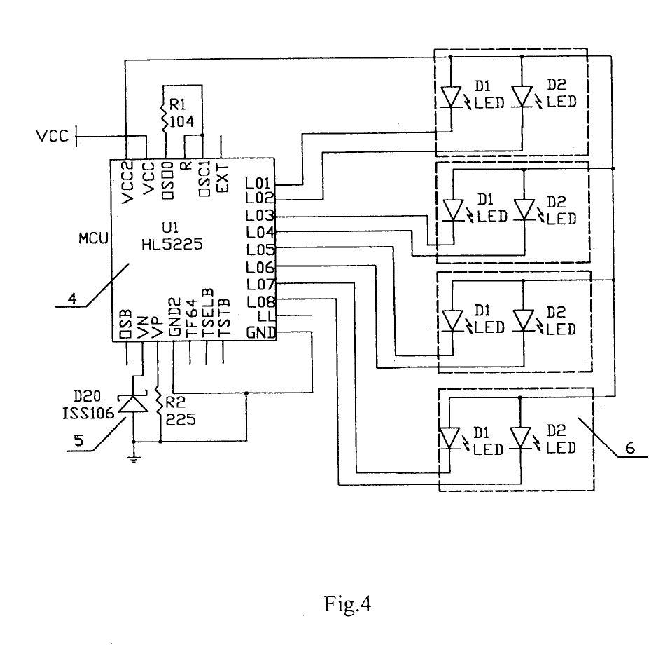

As shown in FIGS. 1 and 2, the basic structure of the luminescent display device provided by the invention, which can be mounted on the surface of an electronic product or mounted in an electronic product and by which the electric signal sent or received by the electronic product triggers the device to work, is a luminescent unit 2 mounted on a circuit board 1, an integrated module 4 that controls luminescent unit 2, an electric signal trigger 5 which receives electric signal to send control signal to integrated module 4 and adaptor 101/102 installed on circuit board 1 and connected to the power supply of the electronic product.

By mounting the circuit board mounted with electronic elements in the battery plate of a mobile phone, a battery plate capable of emitting light can be built, as shown in FIG. 3. To show luminescent effect, transparent material shall be used for the front cover 11 and back cover 10 of the battery plate. The circuit board of the luminescent device 8 will be installed between battery cell 9 and battery front cover 11. When device 8 is connected to the power supply, it will work automatically for 10 seconds (self detect) and return to standby status. When a calling signal reaches or the mobile phone sends a signal out, the high-frequency signal in the phone is detected as a control signal by the electric signal in the device to trigger the work of integrated module 4, and then the integrated module drives luminescent unit 2 connected to it to emit light. When the signal intermits for 3 seconds, the device will be restored to standby status.

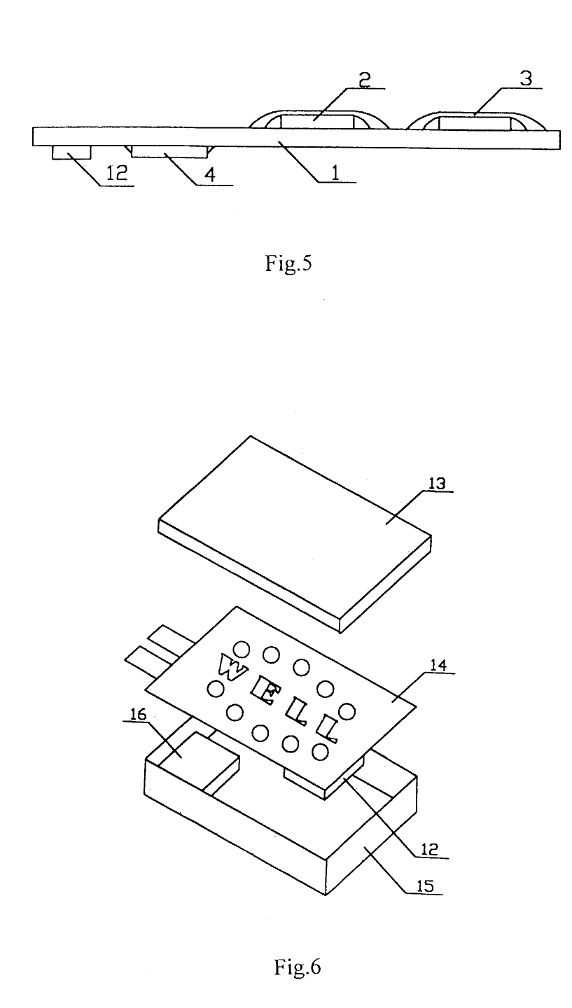

Its schematic circuit diagram is shown in FIG. 5. The integrated module 4 that drives the luminescent unit to emit light is HL5225 type and the electric signal trigger 5 adopts ISS106 type trigger diode to control integrated module 4. In order to keep the device as thin as possible, diodes and the elements in the device are installed on the circuit board as mounted elements. The integrated module 4 shown in the figure can drive 4 luminescent components to emit light.

The luminescent unit 2 in the abovementioned luminescent device can adopt several light-emitting diodes that are regularly distributed on the mentioned circuit board (If required, several light-emitting diodes can form a flower pattern or other character shapes). For different decorative purposes, several light-emitting diodes can be of a same color or different colors. To enhance the light-emitting decorative effect, the exposed surfaces of light-emitting diodes can be covered with crystal mixed glue (or light guide crystal mixed glue) 3.

The abovementioned luminescent device can be mounted on the shell of a mobile phone, applying the same operational principle as that when mounted in a battery plate.

The abovementioned luminescent device can also be mounted on the shell of a car phone charger to make a car phone charger that flashes upon an incoming call.

As shown in FIG. 5, the basic structure of the luminescent display device provided by the invention, which can be mounted on the surface of an electronic product or mounted in an electronic product and by which the electric signal sent or received by the electronic product triggers the device to work, is a luminescent unit 2 mounted on a circuit board 1, an integrated module 4 that controls luminescent unit 2 and an acoustic control sensor 12 that receives trigger signal to send control signal to integrated module 4.

By embedding the circuit board mounted with electronic elements in an electronic billboard, an electronic billboard that can emit light can be made, as shown in FIG. 6. To show luminescent effect, transparent material shall be used for the front cover 13 of the battery electronic billboard. The circuit board of the luminescent device 14 will be installed between the front cover 13 and back cover 15 of the electronic billboard and the battery cell 16 will be installed in the back cover 15. When device 8 is connected to the power supply, the electronic billboard will go into standby status. The electronic billboard is applicable for areas where quietness is required, such as hospital and aged persons home, etc. Upon loud human noise or any other high-decibel noises, the acoustic control sensor detects the sound signal as a control signal and triggers the work of integrated module 4, and then the integrated module drives luminescent unit 2 connected to it to emit light with indications of character combination or alert pattern, such as: Please keep quiet and a gesture for silence, etc.

The luminescent unit 2 in the luminescent device can adopt several light-emitting diodes that are regularly distributed on the circuit board (If required, several light-emitting diodes can form a flower pattern or other character shapes). For different decorative purposes, several light-emitting diodes can be of a same color or different colors. To enhance the light-emitting decorative effect, the exposed surfaces of light-emitting diodes can be covered with crystal mixed glue (or light guide crystal mixed glue) 3.

The luminescent device is also applicable for service and entertainment sites, such as hotel, restaurant, amusement park, park and entertainment town, etc. When a customer comes, the acoustic control sensor detects the sound signal as a control signal and triggers the work of integrated module 4, and then the integrated module drives luminescent unit 2 connected to it to emit light with display of “WELCOME”, etc.

Besides an acoustic sensor, the abovementioned sensor can be an optical control sensor or an infrared sensor.

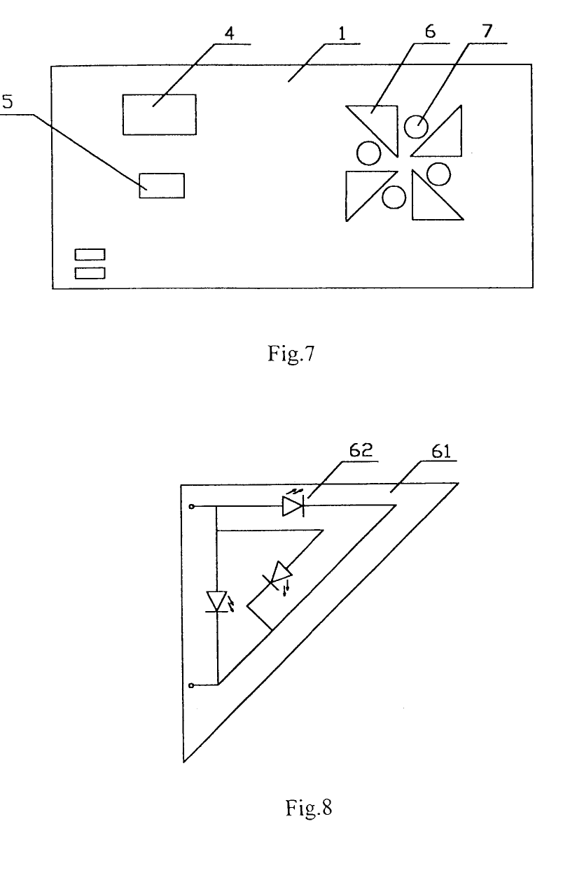

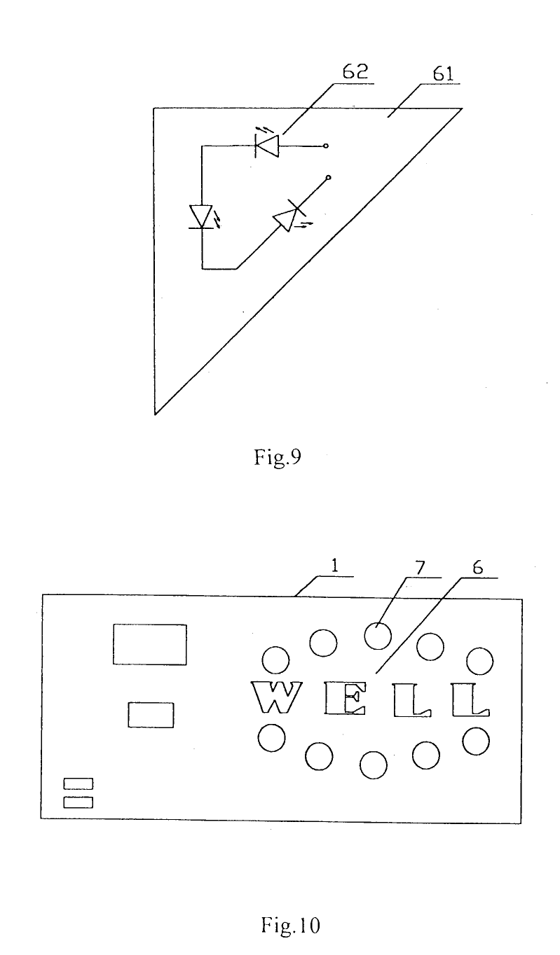

In the invention as a luminescent device, the luminescent unit installed on circuit board 1 can be realized by several luminescent components. As shown in FIGS. 7/8/9, a luminescent component 6 is formed by a triangular small circuit board 61 and several light-emitting diodes 62 installed on triangular small circuit board 61 in parallel connection (as shown in FIG. 8) or in series (as shown in FIG. 9);

In the luminescent device, the luminescent unit can be formed by one luminescent component 6 or several luminescent components 6 installed on the circuit board in a way that forms a flower pattern (as shown in FIG. 7). And by installing a single luminescent element 7 (light-emitting diode) between two adjacent luminescent components, the light-emitting effect can be enhanced.

By embedding the circuit board of the abovementioned luminescent device in the battery plate of a mobile phone, a battery plate that can emit light can be made, as shown in FIG. 3. Transparent material shall be used for the front cover 11 and back cover of the battery plate. The luminescent device 8 will be installed between battery cell 9 and battery front cover 11, applying the same operational principle as that of Example 1. Also, the luminescent device can be mounted on the shell of a mobile phone, applying the same operational principle as that when mounted in a battery plate. Still another application is to mounting the luminescent device onto the shell of a car phone charger to make a car phone charger that flashes upon an incoming call.

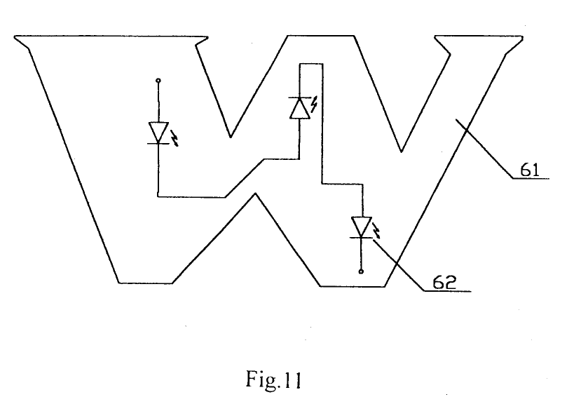

In the invention as a luminescent device, the luminescent unit installed on circuit board 1 can be realized by several Luminescent components. As shown in FIGS. 10 and 11, a Luminescent component 6 is formed by a character shaped small circuit board 61 and several light-emitting diodes 62 installed on triangular small circuit board 61 in parallel connection or in series (as shown in FIG. 11);

In the luminescent device, the luminescent unit can be formed by one luminescent component 6 or several Luminescent components 6 installed on the circuit board in a way of character combination (as shown in FIG. 10). And by installing a single luminescent element 7 (light-emitting diode) around several luminescent components, the light-emitting effect can be enhanced.

The circuit board of abovementioned luminescent device can be mounted on battery plate or the shell of a mobile phone to make a battery plate that can emit light. It can also be mounted on the shell of a car phone charger to make a car phone charger that flashes upon an incoming call.

To form different pattern or characters for the invention as a luminescent device, the shape of the circuit board 61 in the Luminescent component 6 can be one of the following: triangle (as shown in FIGS. 8 and 9), round, diamond, square, oval and character shape (as shown in FIG. 11). To enhance decorative effect, the surfaces of the circuit board and light-emitting diodes can be covered with crystal mixed glue or light guide crystal mixed glue.

The luminescent device, according to the present invention, can be assembled in or on the surface of an electronic product, such as the back cover or battery plate of a mobile phone and the surface or inside of an electronic billboard, etc. When a calling signal reaches or an electric signal is sent out or a trigger signal is detected, the electric signal or other trigger signal in the device will detects the control signal and triggers the work of the light-emitting control integrated module 4, and then the integrated module drives luminescent unit connected to it to emit light. By using luminescent units of different combination structures provided by the invention, the luminescent device can make different luminescent effects, so as to enhance the display function and decorative effect of a mobile phone or other electronic products.

One skilled in the art will understand that the embodiment of the present invention as shown in the drawings and described above is exemplary only and not intended to be limiting. It will thus be seen that the objectives of the present invention have been fully and effectively accomplished. The embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A luminescent device for equipping with an electronic product, comprising:
a circuit board for connecting to the electronic product;
a luminescent unit mounted on said circuit board;
an integrated module communicated with said circuit board for controlling said luminescent unit; and
a trigger communicating with said integrated module to receive trigger signals and send control signals to said integrated module in response to said trigger signals.

2. The luminescent device, as recited in claim 1, wherein said trigger is an electric signal trigger mounted on said circuit board.

3. The luminescent device, as recited in claim 1, wherein said luminescent unit comprises at least one light-emitting diode spacedly positioned on said circuit board.

4. The luminescent device, as recited in claim 2, wherein said luminescent unit comprises at least one light-emitting diode spacedly positioned on said circuit board.

5. The luminescent device, as recited in claim 1, wherein said luminescent unit comprises a plurality of light emitting units communicating with said circuit board, wherein said light emitting units are capable of emitting light of different color.

6. The luminescent device, as recited in claim 2, wherein said luminescent unit comprises a plurality of light emitting units communicating with said circuit board, wherein said light emitting units are capable of emitting light of different color.

7. The luminescent device, as recited in claim 3, further comprising a sensor communicating with said trigger.

8. The luminescent device, as recited in claim 4, further comprising a sensor communicating with said trigger.

9. The luminescent device, as recited in claim 5, further comprising a sensor communicating with said trigger.

10. The luminescent device, as recited in claim 6, further comprising a sensor communicating with said trigger.

11. The luminescent device, as recited in claim 1, wherein said luminescent unit comprises a plurality of luminescent components installed on said circuit board in such a manner that said luminescent components are capable of forming a pattern.

12. The luminescent device, as recited in claim 11, wherein each of said luminescent components comprising a small circuit board communicating to said circuit board and a plurality of light-emitting diodes provided on said small circuit board.

13. The luminescent device, as recited in claim 11, further comprising a plurality of luminescent elements and each said luminescent element is provided between two of said adjacent luminescent components.

14. The luminescent device, as recited in claim 12, further comprising a plurality of luminescent elements and each said luminescent element is provided between two of said adjacent luminescent components.

15. The luminescent device, as recited in claim 11, further comprising a plurality of luminescent elements provided around said luminescent components.

16. The luminescent device, as recited in claim 12, further comprising a plurality of luminescent elements provided around said luminescent components.

17. The luminescent device, as recited in claim 1, wherein said luminescent unit comprising a plurality of luminescent components installed on said circuit board such that said luminescent components is capable of arranging in a way in a way of character combination.

18. The luminescent device, as recited in claim 17, wherein each of said luminescent components comprises a small circuit board communicating to said circuit board, and a plurality of light-emitting diodes provided on said small circuit board, wherein said luminescent device further comprises a plurality of luminescent elements provided around said luminescent components.

19. The luminescent device, as recited in claim 1, wherein each corresponding exposed surface of each said luminescent component is covered with crystal mixed glue.

20. The luminescent device, as recited in claim 1, wherein each corresponding exposed surface of each said luminescent component is covered with light guide crystal mixed glue.
